(19) United States
(12) Patent Application Publication
(10) Pub. No.: US 2026/0305599 A1
(43) Pub. Date: Oct. 8, 2026

(54) ANIMAL DETERRENT DEVICES AND METHODS

(71) Applicant: Daniel BARBOSA, Rolla, MO (US)

(72) Inventor: Daniel BARBOSA, Rolla, MO (US)

(21) Appl. No.: 19/560,457

(22) Filed: Mar. 9, 2026

Related U.S. Application Data
(60) Provisional application No. 63/784,913, filed on Apr. 7, 2025.

(51) Int. Cl. A01M 29/18; A01K 29/00; G01S 13/04

(52) U.S. Cl. CPC A01M 29/18; A01K 29/005; G01S 13/04

(57) ABSTRACT

Disclosed herein are exemplary devices and methods for deterring animals (e.g., house pets, outdoor nuisance wildlife, etc.) from performing unwanted behavior, such as entering or approaching a designated area in an indoor or outdoor environment (e.g., countertops, doors, furniture, gardens, planters, trash areas, landscaping, etc.).

### CROSS-REFERENCE TO RELATED APPLICATION

This application claims priority to and the benefit of U.S. Provisional Patent Application No. 63/784,913 filed Apr. 7, 2025, which is incorporated herein by reference in its entirety.

### FIELD

The present disclosure relates to device and methods for deterring animals (e.g., house pets, outdoor nuisance wildlife, etc.) from performing unwanted behavior, such as entering or approaching a designated area in an indoor or outdoor environment (e.g., countertops, doors, furniture, gardens, planters, trash areas, landscaping, etc.).

### BACKGROUND

This section provides background information related to the present disclosure which is not necessarily prior art.

Domestic animals, such as dogs and cats, are known to cause damage to indoor furnishings, plants, flooring, walls, doors, and similar household items by scratching, lying upon, or otherwise accessing such objects. Additionally, when pets are permitted on sanitary food-preparation surfaces (e.g., kitchen countertops), there is an increased risk of transmitting bacteria or other contaminants from the animal's paws onto the preparation area. Attempts to curb these behaviors through manual interventions—such as spraying the animal with water or issuing verbal reprimands—may inadvertently cause the animal to associate the negative stimulus with the owner rather than with the restricted area. Consequently, the undesired behavior may persist whenever the owner is absent.

Wildlife, including but not limited to squirrels, rabbits, raccoons, birds, and similar animals, may also cause significant disruption or damage to outdoor environments such as gardens, landscaped areas, planters, refuse containers, agricultural plots, and comparable locations. These animals may dig, chew, consume vegetation, displace materials, or otherwise disturb the intended condition, utility, or aesthetic of such areas.

Various conventional devices exist that deliver a deterrent stimulus intended to startle or repel an animal. These stimuli may include, for example, the emission of a water spray, the production of a loud auditory signal, the activation of flashing lights, or combinations thereof. Conventional deterrence methods—such as fencing, chemical repellents, physical barriers, or human intervention—frequently exhibit inconsistent effectiveness, require recurring upkeep, or impose substantial labor demands.

Accordingly, automated animal-deterrence systems are desirable. Such automatic deterrence can be especially helpful in preventing an animal from associating corrective action with its owner and can provide continuous protection in both indoor and outdoor environments.

### DRAWINGS

The drawings described herein are for illustrative purposes only of selected embodiments and not all possible implementations and are not intended to limit the scope of the present disclosure.

FIG. 1 is a perspective view of an animal deterrent device according to an exemplary embodiment of the present disclosure. In this exemplary embodiment shown in FIG. 1, the deterrent device includes an alignment laser, ultrasonic transducers, and speakers. The alignment laser is usable to aid in alignment of the animal presence detector (e.g., laser tripwire-like functionality of a distance sensor, etc.) of the animal deterrent device. The ultrasonic transducers are operable for generating ultrasonic sound in response to detection of an animal by the animal presence detector. The speakers are operable for emitting the ultrasonic sound generated by the ultrasonic transducers. The emitted ultrasonic sound is intended to harmlessly startle or scare the animal to thereby cause the animal to move away from or leave the designated area. Through continued use of the animal deterrent device, the animal may eventually be trained from entering or being in close proximity to the designated area.

FIG. 2 illustrates an example usage of the animal deterrent device shown in FIG. 1 on a kitchen countertop. A pet detected along the red line shown in FIG. 2 will trigger an alarm (e.g., laser tripwire-like functionality, etc.). In response to the alarm being triggered, the deterring stimulus emitter of the animal deterrent device will automatically emit ultrasonic noise intended to harmlessly startle or scare the animal to thereby cause the animal to move away from or leave the designated area. Through continued use of the animal deterrent device, the animal may eventually be trained from entering or being in close proximity to the designated area.

FIG. 3 illustrates another example usage of the animal deterrent device shown in FIG. 1 on a kitchen island. In this example, the user can adjust the designated off-limits areas such that the animal deterrent device will only trigger an alarm when anomalies (e.g., dogs, cats, etc.) are detected within user-set distances (represented by red lines).

FIG. 4 illustrates an approximate sensing path of the animal deterrent device shown in FIG. 1. In some exemplary embodiments, the animal deterrent device may be configured to have an adjustable field of view (FoV) that allows the user to switch between tripwire-like detection (represented by the red line) or more expansive, general object detection (represented by the green lines and similar to a smartphone's facial recognition).

FIG. 5 illustrates example internal assemblies of the animal deterrent device shown in FIG. 1.

FIGS. 6 through 12 respectively include perspective, front, back, left side, right side, top, and bottom views of the animal deterrent device shown in FIG. 1.

FIG. 13 illustrates a perspective view of an animal deterrent device according to another exemplary embodiment of the present disclosure. In this exemplary embodiment shown in FIG. 13, the deterrent device includes a spherical laser and sensor housing, a sensor hole, and an outer nut to lock an adjustment mechanism.

FIG. 14 includes a top view of the animal deterrent device shown in FIG. 13.

FIGS. 15 and 16 respectively include exploded perspective views of the animal deterrent device shown in FIG. 1 according to an exemplary embodiment.

FIGS. 17 through 22 respectively include top, bottom, front, back, left side, and right side views of the animal deterrent device shown in FIG. 15.

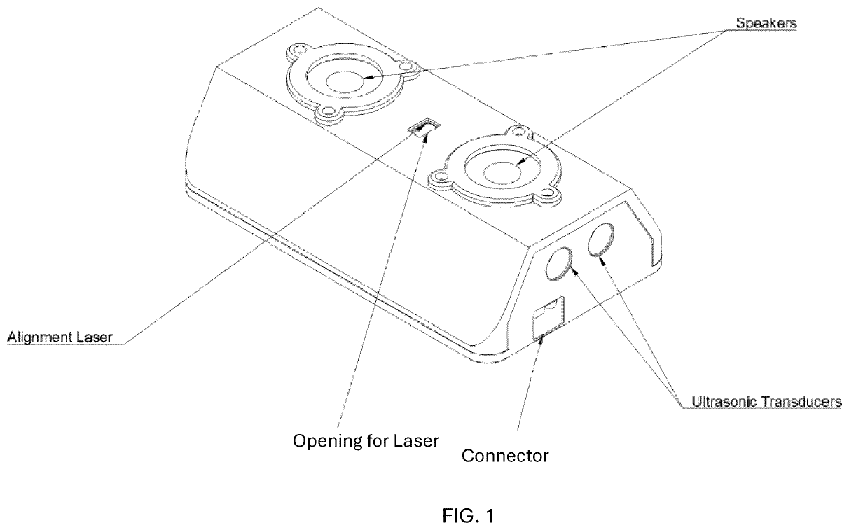

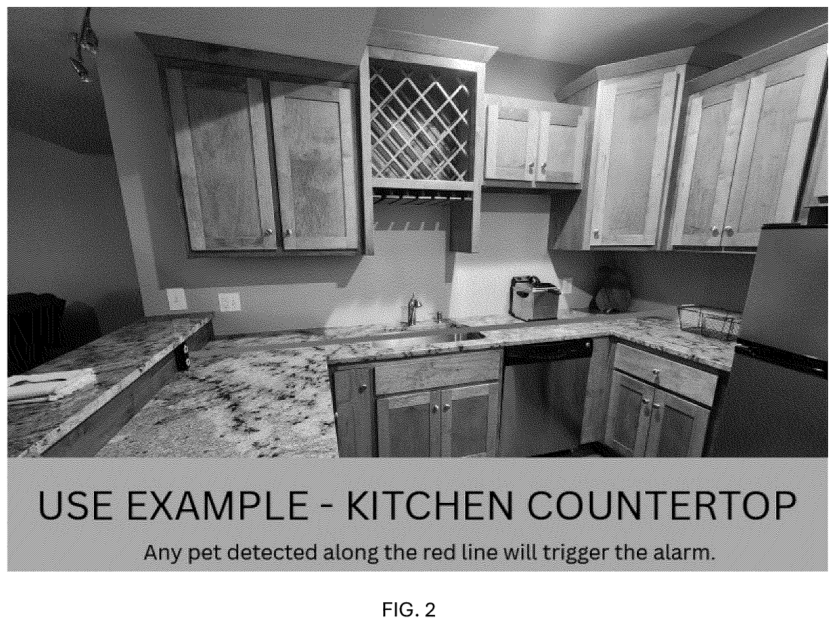

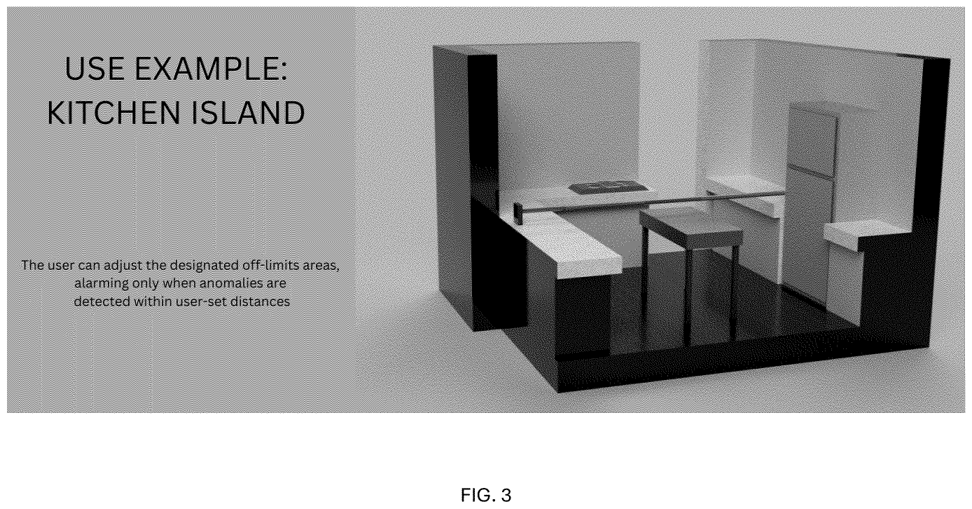

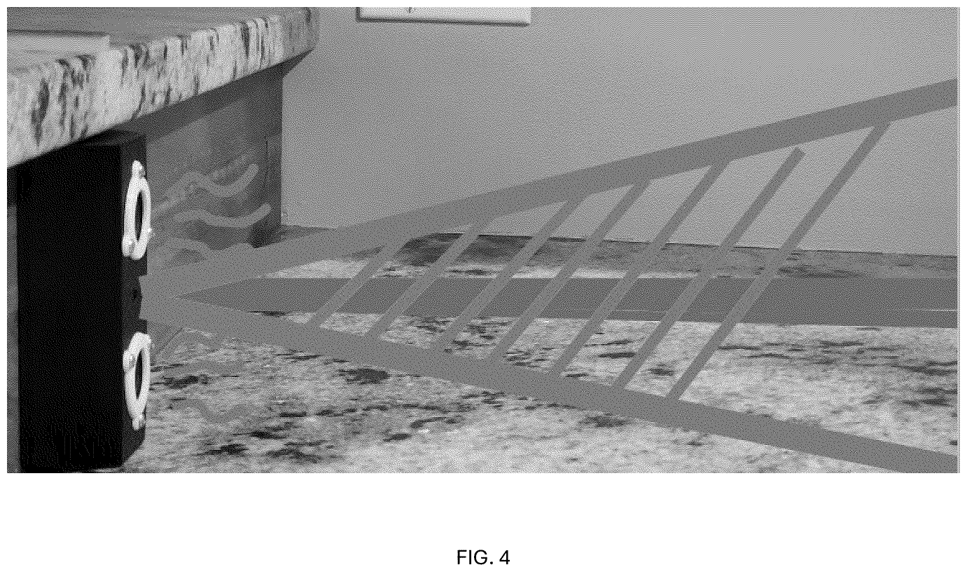

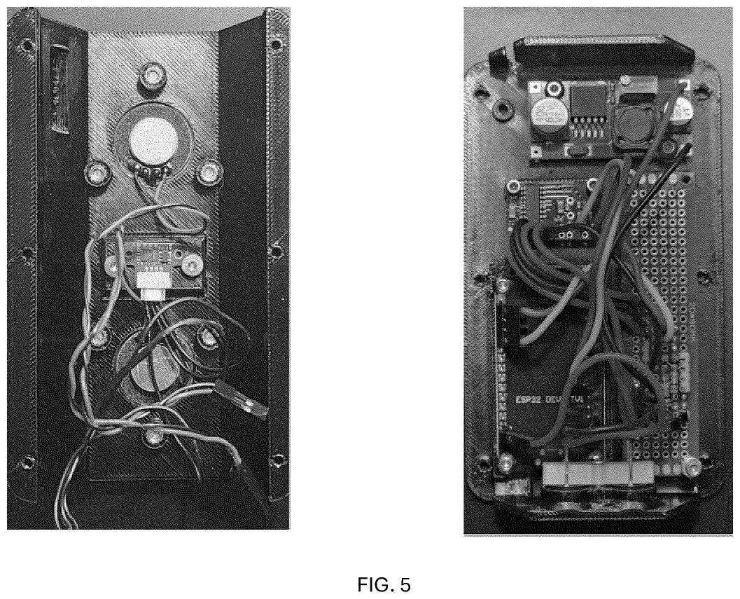

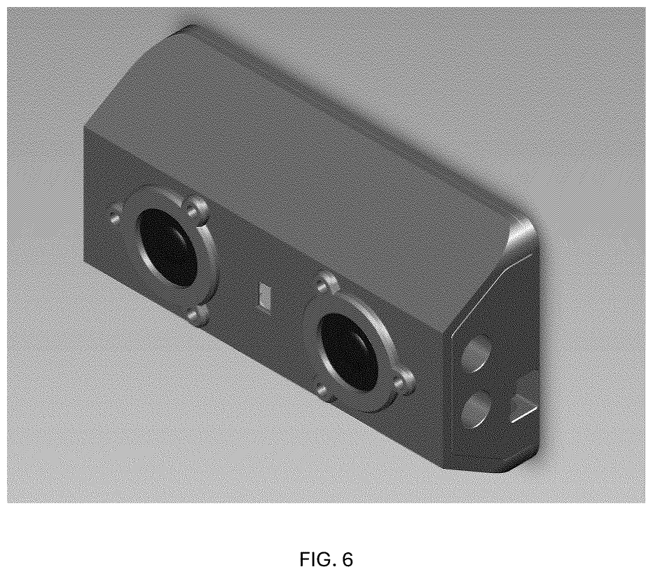

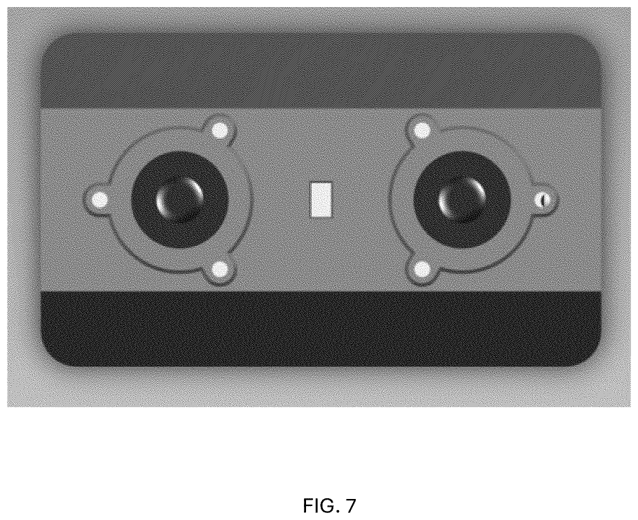

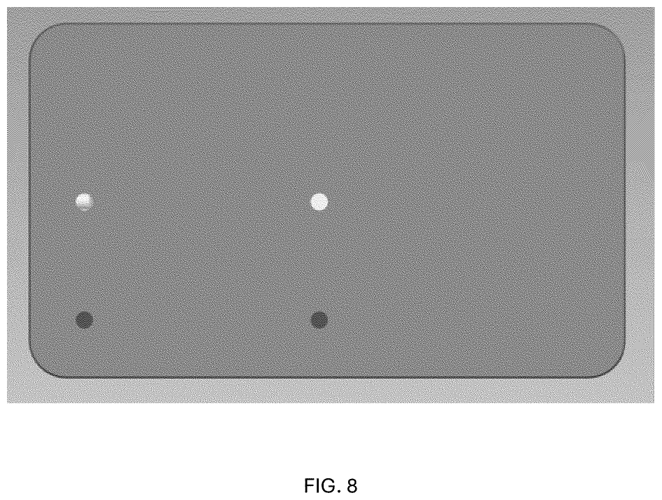

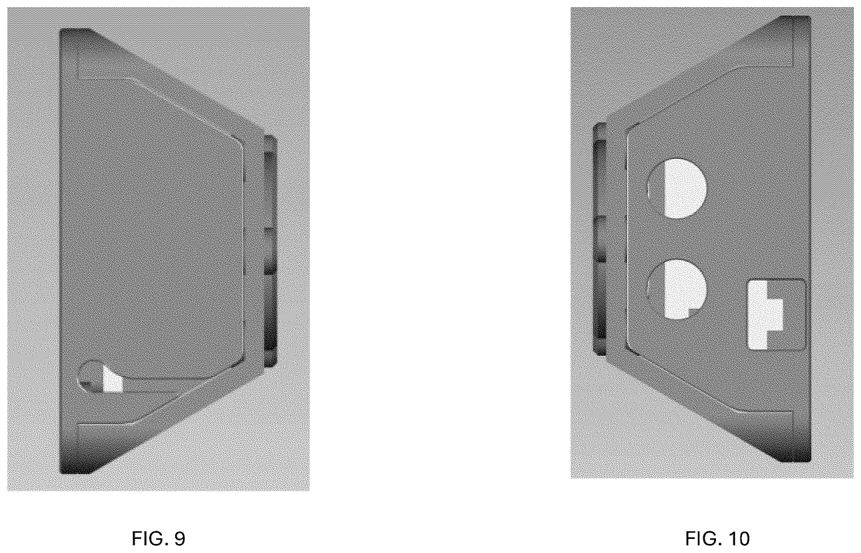

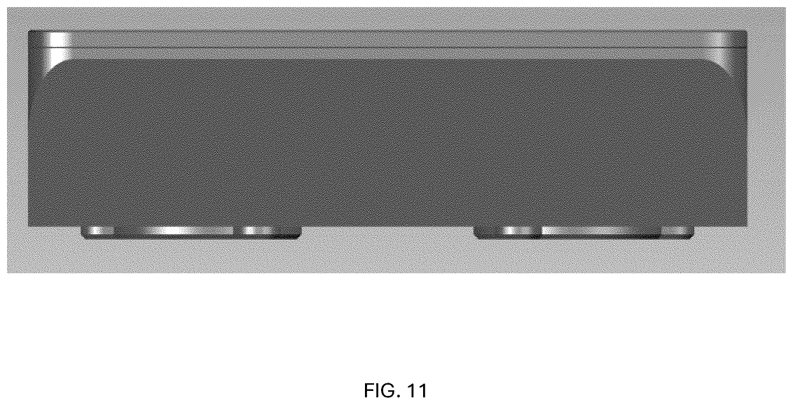

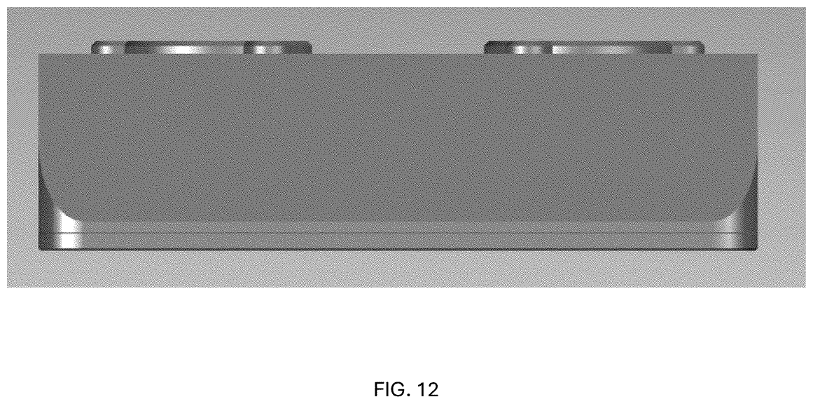

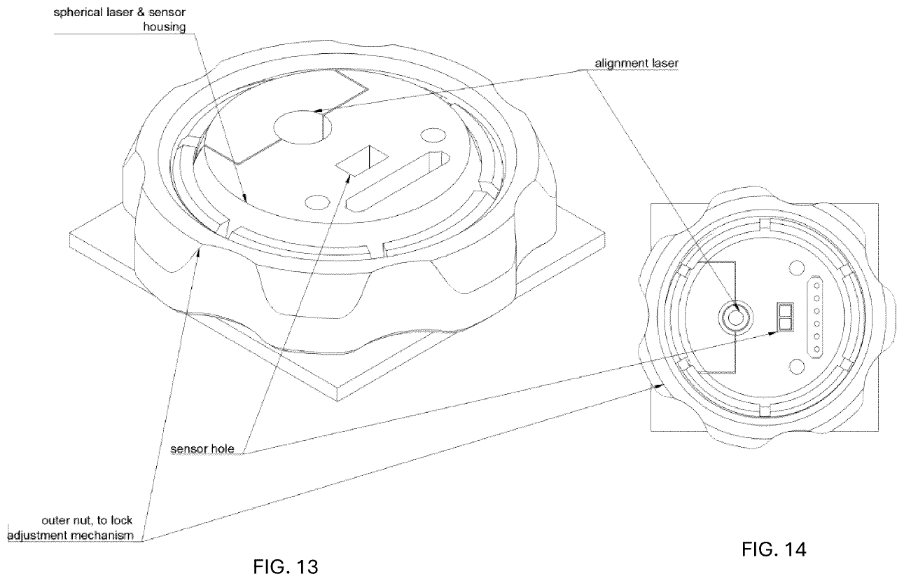

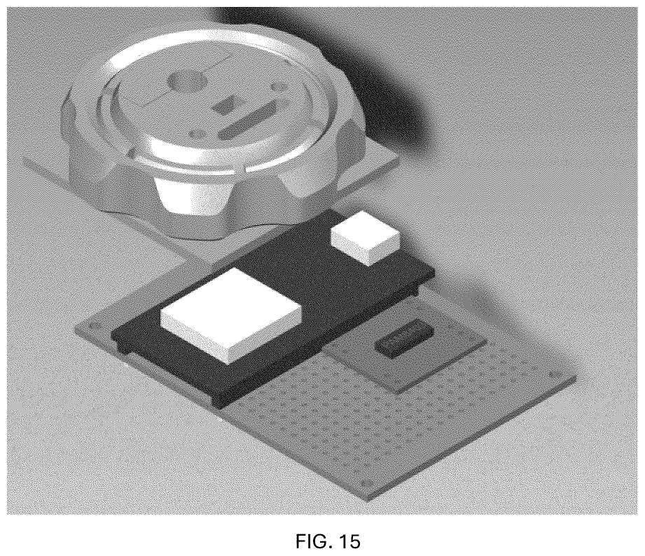

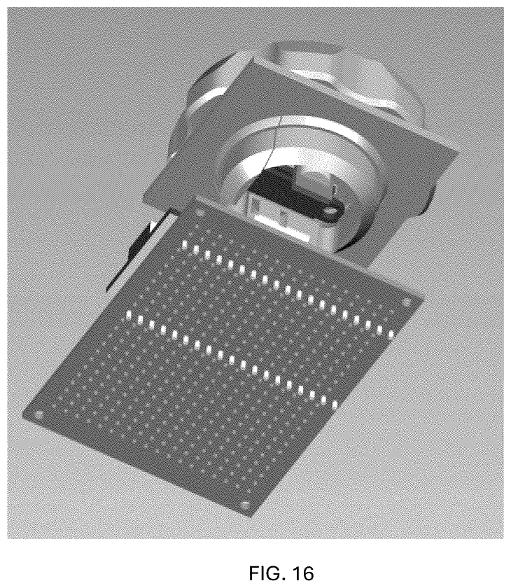

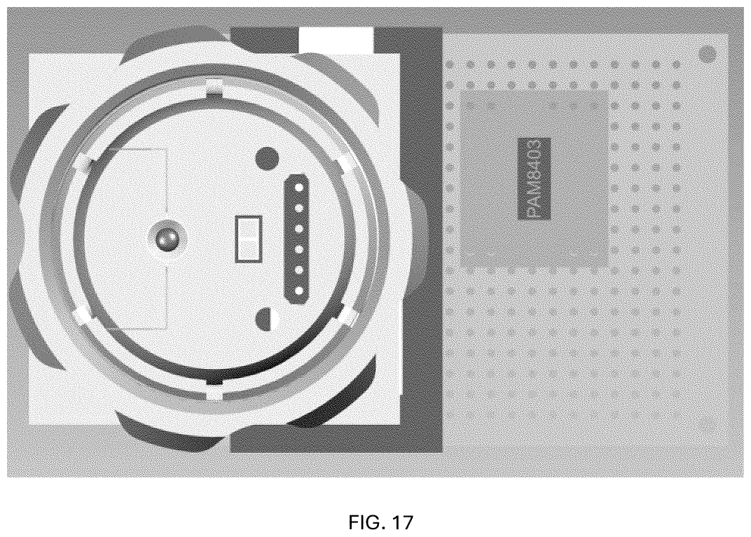

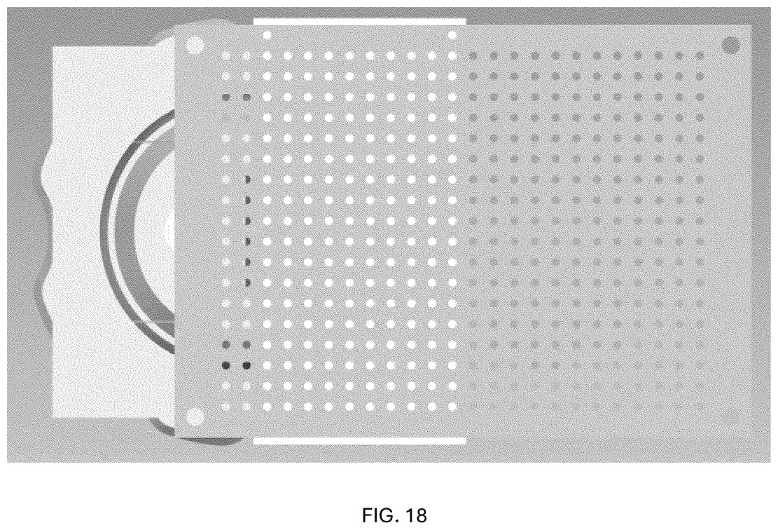

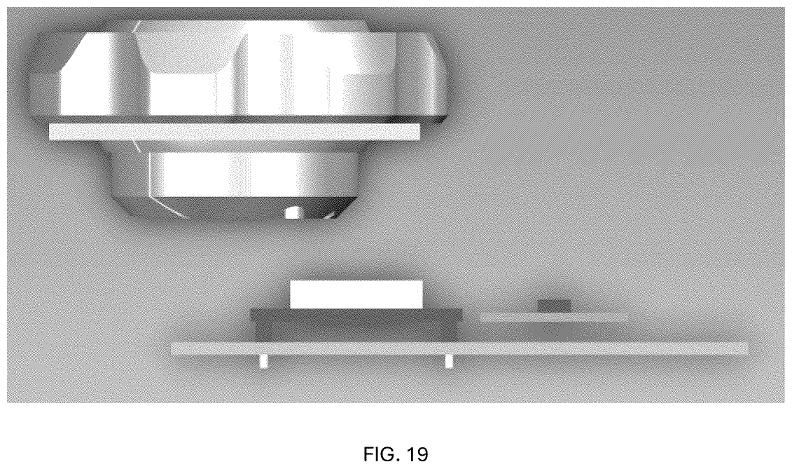

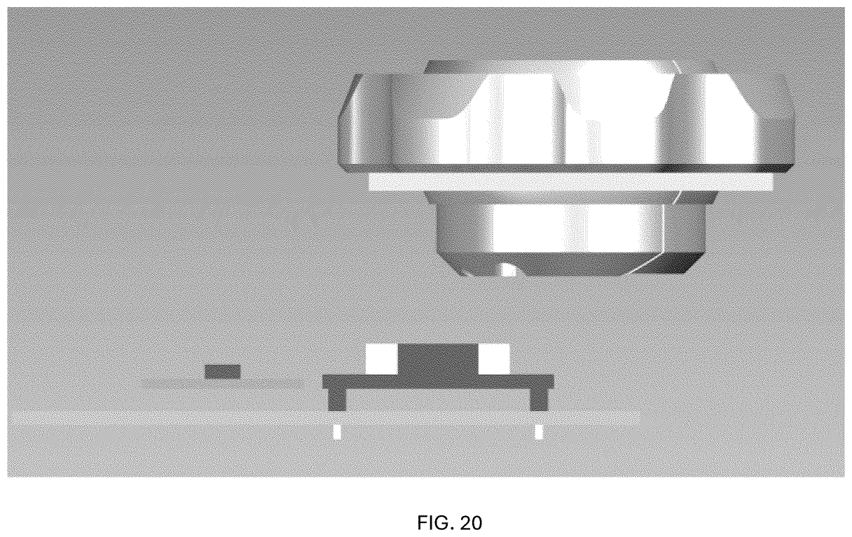

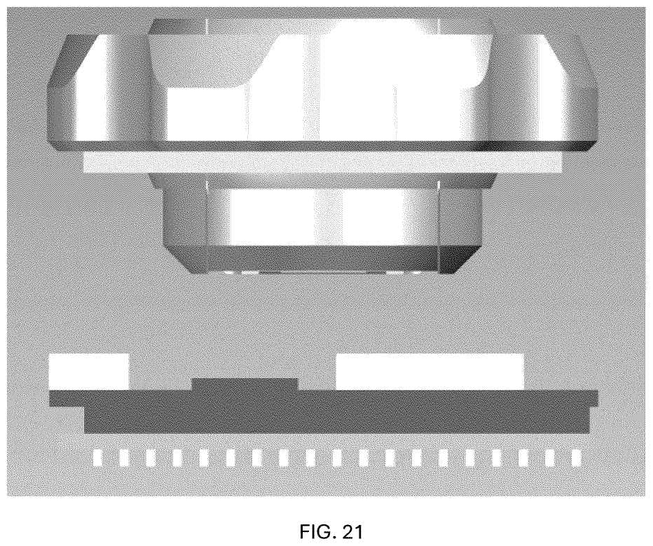

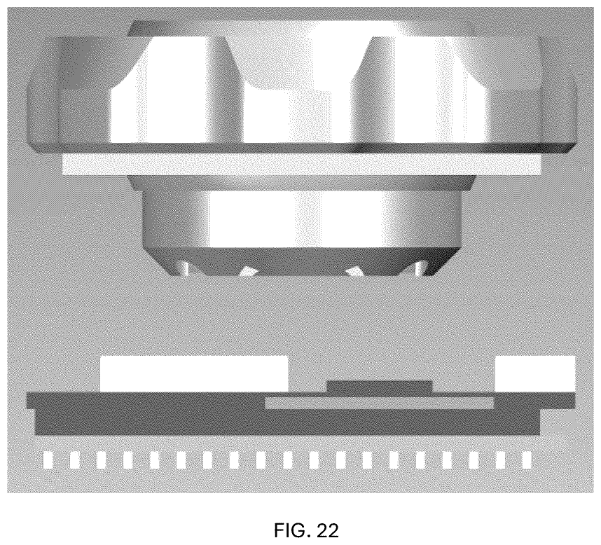

### DETAILED DESCRIPTION

Example embodiments will now be described more fully with reference to the accompanying drawings.

Wildlife, including but not limited to squirrels, rabbits, raccoons, birds, and similar animals, may also cause significant disruption or damage to outdoor environments such as gardens, landscaped areas, planters, refuse containers, agricultural plots, and comparable locations. These animals may dig, chew, consume vegetation, displace materials, or otherwise disturb the intended condition, utility, or aesthetic of such areas.

In addition, dogs and cats (broadly, house pets) have been known to cause harm to indoor furnishing, plants, and flooring/walls/doors by scratching, lying upon, and in general having access to such objects. Additionally, allowing pets onto sanitary preparation surfaces, like kitchen countertops, increases the likelihood of transferring residual bacteria from the pet's paws onto the preparation surfaces.

Various conventional devices exist that deliver a deterrent stimulus intended to startle or repel an animal. These stimuli may include, for example, the emission of a water spray, the production of a loud auditory signal, the activation of flashing lights, or combinations thereof. Conventional deterrence methods—such as fencing, chemical repellents, physical barriers, or human intervention—frequently exhibit inconsistent effectiveness, require recurring upkeep, or impose substantial labor demands.

As recognized herein, combating these behaviors by manually spraying water or verbally disciplining the pet may cause the pet to associate the negative interaction with the owner rather than the prohibited area. As a result, the pet may continue the unwanted behavior in the absence of their owner. As further recognized herein, automated animal-deterrence systems are desirable. Such automatic deterrence can be especially helpful in preventing an animal from associating corrective action with its owner and can provide continuous protection in both indoor and outdoor environments.

After recognizing the above, exemplary devices and methods were developed and/or disclosed herein for deterring animals (e.g., house pets, outdoor nuisance wildlife, etc.) from performing unwanted behavior, such as entering, approaching, or being present within a designated area in an indoor or outdoor environment (e.g., countertops, doors, furniture, gardens, planters, trash areas, landscaping, etc.). In exemplary embodiments, an animal deterrent device includes an animal presence detector (e.g., sensor, etc.) and a deterring stimulus emitter (e.g., white noise emitter, ultrasonic sound emitter, dynamic or modulated audio profiles, frequency sweeps, amplitude-modulated noise, randomized or pseudo-random noise patterns, pre-recorded audio files, user-recorded audio, temporally varying acoustic signals, other sound emitter, other deterring stimulus, etc.).

The animal presence detector is configured to be operable for automatically detecting an animal entering, approaching, or being present within the designated area depending on the configuration of the animal deterrent device. The deterring stimulus emitter is configured to be operable for automatically emitting a deterring stimulus in response to the animal presence detector detecting the animal entering, approaching, or being present within the designated area. The deterring stimulus is intended to startle or scare the animal to thereby cause the animal to move away from or leave the designated area. Through continued use of the animal deterrent device, the animal may eventually be trained from entering or being in close proximity to the designated area. Accordingly, the animal deterrent device enables a method for automatically deterring the animal and therefore reinforces the pet associating the negative interaction with the deterring stimulus with the prohibited area or behavior instead of associating the negative interaction with the deterring stimulus to its owner.

In some exemplary embodiments, the animal deterrent device is configured for operation in indoor and/or outdoor environments, including residential, commercial, and agricultural settings.

In some exemplary embodiments, the deterring stimulus emitter is configured to generate dynamic or modulated audio profiles. Such profiles may include frequency sweeps, amplitude-modulated noise, randomized or pseudo-random noise patterns, or other temporally varying acoustic signals. In some exemplary embodiments, the deterring stimulus emitter is further configured to reproduce pre-recorded audio files, user-recorded audio, and/or other sound files that are uploaded to the device via wired or wireless communication interfaces.

In some exemplary embodiments, the device is configured to differentiate between at least one animal and at least one human using a classification algorithm executed by the local controller and/or a remote cloud-based computing service. The classification algorithm may include, for example, a machine-learning model, neural network, rule-based logic system, statistical classifier, or other computational method trained or configured to distinguish humans from animals based on sensor-derived data. The algorithm may utilize data from one or more sensors, including, but not limited to, millimeter-wave (mmWave) sensors, cameras, LiDAR sensors, time-of-flight sensors, ultrasonic sensors, and/or the primary animal-presence detector. In some exemplary embodiments, sensor-fusion techniques are employed to combine data from multiple sensors to improve classification accuracy. The classification algorithm may additionally determine a quantity of detected animals and/or identify whether one or more humans are present concurrently with one or more animals.

In some exemplary embodiments, the deterring stimulus emitter may comprise a white noise emitter (broadly, a sound emitter) operable for emitting white noise (e.g., sudden “hiss-like” noise, etc.) through one or more speakers to harmlessly startle the animal and thereby deter the animal from performing the unwanted behavior. Or, for example, the deterring stimulus may comprise ultrasonic sound produced by one or more ultrasonic sound emitters. The designated area may comprise any location or area as designated by the end user when setting up the animal deterrent device, such as furniture (e.g., couch, chair, table, etc.), a room or portions thereof, plants, indoor or outdoor gardens, kitchen countertops, kitchen islands, among other locations and areas.

In exemplary embodiments, the animal deterrent device includes a housing, a controller within the housing, and a sound emitter (broadly, a deterring stimulus emitter) within the housing. A distance sensor (broadly, an animal presence sensor) is provided on the housing. The distance sensor is operable for providing distance measurements to the controller, which detects physical anomalies in the designated area, thereby activating the sound emitter. The distance sensor's angular direction is adjustable. Additionally, the distance sensor may be configured to have an adjustable field of view.

A laser may be rigidly constrained to the distance sensor's adjustability. The laser can be enabled and/or disabled to aid in alignment of tripwire-like functionality of the distance sensor. Additionally, a human presence sensor can be used to disarm the animal deterrent emission when a human is detected in the sensor's range. For example, the animal deterrent device may be automatically disarmed when a human is detected in the human presence sensor's range, e.g., within a kitchen in which the designated area has been established, etc. The human presence sensor may use mmWave radar, camera identification, Light Detection and Ranging (LiDAR), etc. The animal deterrent device may be connectable with a smart-device via Bluetooth or Wi-Fi to enable a user to configure the animal deterrent device's settings, e.g., cutoff distance, sensitivity, schedule, etc.

The housing may be comprised of a base-unit to which different (e.g., two, etc.) types of attachments may be equipped. For example, various mounts may be attachable to a universal attachment point on the back/bottom of the animal deterrent device. Additionally, or alternatively, various covers may be attachable to a universal attachment point on the front of the animal deterrent device to suit various cosmetic preferences, e.g., ranging from simple cover to decorative cover to match kitchen décor, etc.

In exemplary embodiments, the animal deterrent device includes a distance sensor operable for detecting changes in distance reading to determine animal presence. The animal deterrent device is configured to automatically determine “nominal distance” based on the past number of readings. Upon detection of animal presence, the animal deterrent device emits a deterring stimulus, e.g., white noise (to mimic hissing) is emitted through speakers, etc. Upon redetermining “nominal distance”, the animal deterrent device is re-armed.

Some exemplary embodiments may also be configured with one or more of angular adjustability for the distance sensor and alignment laser, modular mounts, adjustable field of view, an ultrasonic sound emitter, and/or a stripped down/simplified user interface including buttons instead of smart-device connectivity, etc.

In exemplary embodiments, an animal deterrent device comprises a housing, a controller within the housing, an animal presence sensor, and a deterrent mechanism. The housing may be modular such that a decorative cover may be installed for aesthetics and/or such that various mounts and/or stands can be fitted to the housing. The controller may be programmable via an on-board interface and/or via a smartphone app through Bluetooth and/or Wi-Fi connectivity.

The animal presence sensor may comprise a distance sensor configured to measure distance to a subject for detection of an animal. For example, the distance sensor may comprise a Light Detection and Ranging (LiDAR) sensor that utilizes pulsed lasers to measure distances. Or, for example, the distance sensor may comprise a Time of Flight (ToF) sensor. As yet another example, the distance sensor may comprise an ultrasonic sensor.

The deterrent mechanism may comprise a sound emitter. For example, the sound emitter may comprise an ultrasonic sound emitter (ultrasonic transducer) and speaker (frequencies of 20 hertz (Hz) to 20 kilohertz (kHz).

In at least some exemplary embodiments, the animal deterrent device further includes at least one, two, or any combination of: (1) an alignment mechanism, (2) a human presence sensor, and (3) a battery pack or no battery pack. In other words, the animal deterrent device may include any one or combination of two or more of the alignment mechanism, human presence sensor, and battery pack/no battery pack.

In exemplary embodiments of the animal deterrent device that include the alignment mechanism, the alignment mechanism may comprise a mechanically-adjustable sensor mount. In turn, the mechanically-adjustable sensor mount may comprise a rigidly-fixed laser diode for visual alignment and a rigidly fixed animal presence sensor.

In exemplary embodiments of the animal deterrent device that include the human presence sensor, the human presence sensor is configured to be usable for differentiating between at least one animal and at least one human for auto-disarming or modification of operation of the animal deterrent device. The human presence sensor may be disposed within the housing of the animal deterrent device. And the human presence sensor may comprise a 24 GHz mmWave presence sensor, a 60 GHz mmWave presence sensor, a camera, and/or a Light Detection and Ranging (LiDAR) sensor.

In exemplary embodiments of the animal deterrent device that include the battery pack, the animal deterrent device may comprise a rechargeable lithium-ion battery pack within the housing. The rechargeable lithium-ion battery pack may be a removable rechargeable lithium-ion battery pack that is readily removable from the housing. Or the rechargeable lithium-ion battery pack may be nonremovable rechargeable lithium-ion battery pack that is not readily removable from the housing. In addition to, or as an alternative to the battery pack, the animal deterrent device may be configured (e.g. with a battery compartment, etc.) to be electrically powered via AA batteries, AAA batteries, 9 volt battery, etc. Additionally, or alternatively, the animal deterrent device may be configured (e.g., with a power cord, etc.) to be electrically powered by simply plugging the animal deterrent device into an outlet (e.g., a wall outlet, etc.).

Various aspects of the invention according to the present disclosure include, but are not limited to, the aspects listed in the following numbered clauses.

Clause 1. An animal deterrent device comprising: a housing; a controller disposed in the housing; an animal presence detector operable to detect an animal entering, approaching, or present within a designated area; and a deterrent mechanism operable to emit a deterring stimulus in response to detection by the animal presence detector, wherein the deterring stimulus comprises acoustic output from at least one sound emitter.

Clause 2. The device of clause 1, wherein the animal presence detector includes a distance sensor that provides distance measurements to the controller, and the controller identifies a physical anomaly within the designated area based on the measurements and activates the deterrent mechanism in response.

Clause 3. The device of clause 1 or 2, wherein the animal presence detector includes a distance sensor, and at least one of an angular orientation and a field of view of the distance sensor is adjustable.

Clause 4. The device of clause 3, further comprising an alignment laser rigidly constrained to the distance sensor's adjustability and selectively enableable to aid alignment of a tripwire like detection path.

Clause 5. The device of any one of clauses 1 to 4, wherein the sound emitter is configured to emit one or more of: white noise, modulated noise, frequency sweeps, amplitude modulated noise, randomized or pseudo random noise, ultrasonic sound, pre-recorded audio, and/or user recorded audio.

Clause 6. The device of clause 5, wherein the controller generates dynamic, temporally varying audio profiles and/or reproduces audio files uploaded via a wired or wireless communication interface.

Clause 7. The device of any one of clauses 1 to 6, further comprising a human presence sensor, and wherein responsive to detection of a human by the human presence sensor the device is automatically disarmed or its operation is modified.

Clause 8. The device of clause 7, wherein the human presence sensor comprises at least one of: a millimeter wave (mmWave) sensor, a camera, or a Light Detection and Ranging (LiDAR) sensor.

Clause 9. The device of any one of clauses 1 to 8, wherein the animal presence detector includes a distance sensor comprising at least one of: a LiDAR sensor, a time of flight sensor, or an ultrasonic sensor.

Clause 10. The device of any one of clauses 1 to 9, wherein the sound emitter comprises at least one ultrasonic transducer, and optionally a loudspeaker operable within an audio band of about 20 Hz to about 20 kHz.

Clause 11. The device of any one of clauses 1 to 10, wherein the controller is programmable via an on board interface and/or via a smartphone application through Bluetooth and/or Wi Fi connectivity.

Clause 12. The device of any one of clauses 1 to 11, wherein the housing is modular to accept interchangeable decorative covers, mounts, and/or stands.

Clause 13. The device of any one of clauses to 1 to 12, further comprising a power source selected from: (i) a removable or non-removable rechargeable lithium ion battery pack, (ii) replaceable primary batteries such as AA, AAA, or 9 V batteries, and (iii) an AC power input via an electrical power cord.

Clause 14. The device of any one of clauses 1 to 13, wherein the controller executes a classification algorithm to differentiate a human from an animal using data from one or more sensors comprising at least one of: the animal presence detector, a mmWave sensor, a time of flight sensor, an ultrasonic sensor, a camera, or a LiDAR sensor.

Clause 15. The device of clause 14, wherein the classification algorithm comprises a machine learning model, a neural network, a rule based logic system, or a statistical classifier, optionally employing sensor fusion of multiple sensor modalities.

Clause 16. The device of clause 14 or 15, wherein the classification algorithm is executed by the controller and/or a remote cloud based computing service.

Clause 17. The device of clause 14, 15, or 16, wherein the classification algorithm determines at least one of: a number of detected animals, a concurrent presence of a human and one or more animals, or a type or category of a detected animal.

Clause 18. An animal deterrent device comprising: a housing; a controller in the housing; a distance sensing animal presence detector having an adjustable aiming direction; and an acoustic deterrent including (i) an ultrasonic transducer operable above 20 kHz and (ii) a loudspeaker operable between about 20 Hz and about 20 kHz, the controller driving at least one of the ultrasonic transducer and the loudspeaker to emit a deterrent audio profile upon detection of the animal.

Clause 19. The device of clause 18, further comprising an alignment laser rigidly co aligned with the adjustable aiming direction.

Clause 20. The device of clause 18 or 19, wherein the deterrent audio profile includes at least one of: a frequency sweep across ultrasonic and/or audible bands, an amplitude modulated noise burst, or a randomized sequence of audio bursts.

Clause 21: The device of any one of clauses 1 to 20, wherein the animal presence detector includes a distance sensor.

Clause 22: The device of any one of clauses 1 to 21, wherein the animal presence detector includes a mmWave sensor.

Clause 23: The device of any one of clauses 1 to 22, wherein the animal presence is configured to use a spatial detection method for detecting an animal entering, approaching, or being present within a designated area.

Clause 24: The device of any one of clauses 1 to 23, wherein the animal presence detector is configured to use a spatial detection method for detecting an animal entering, approaching, or being present within a designated area, and wherein the spatial detection method excludes using Passive Infrared (PIR) motion detectors but may include using one or more of sensor monitoring of a 3-dimensional space, a camera, and a mmWave sensor.

Clause 25. A method of deterring an animal from a designated area, the method comprising: detecting (e.g., via a distance sensor, a mmWave sensor, spatial detection, etc.) the animal entering, approaching, or present within the designated area; and in response to the detecting, automatically emitting a deterring stimulus comprising acoustic output to startle the animal and cause the animal to move away from the designated area.

Clause 26. The method of clause 25, wherein the method includes detecting., via a distance sensor, the animal entering, approaching, or present within the designated area; and adjusting an angular orientation and/or a field of view of the distance sensor, optionally using an alignment laser co aligned to the distance sensor.

Clause 27. The method of clause 25 or 26, wherein the acoustic output comprises white noise, modulated noise, a frequency sweep, amplitude modulated noise, randomized or pseudo random noise, ultrasonic sound, pre-recorded audio, or user recorded audio.

Clause 28. The method of clause 25, 26, or 27, further comprising detecting presence of a human via a human presence sensor and, responsive to the detection, disarming or modifying operation of the emitting.

Clause 29. The method of clause 28, further comprising classifying a detected subject as a human or an animal using sensor data from at least one of: the distance sensor, a mmWave sensor, a time of flight sensor, an ultrasonic sensor, a camera, or a LiDAR sensor.

Clause 30. The method of clause 29, wherein classifying comprises executing a machine learning model, neural network, rule based logic, or statistical classifier using sensor fusion of multiple modalities, the classifying being performed locally and/or by a remote cloud based computing service.

Clause 31. The method of any one of clauses 25 to 30, further comprising determining a nominal distance baseline from historical readings and re-arming emission of the deterring stimulus after the nominal distance is re-established.

Clause 32. The method of any one of clauses 25 to 31, wherein the method includes detecting., via a distance sensor, the animal entering, approaching, or present within the designated area.

Clause 33. The method of any one of clauses 25 to 32, wherein the method includes detecting., via a mmWave sensor, the animal entering, approaching, or present within the designated area.

Clause 34. The method of any one of clauses 25 to 33, wherein the method includes detecting., via a spatial detection method, the animal entering, approaching, or present within the designated area.

Clause 35. The method of any one of clauses 25 to 34, wherein the method includes detecting., via a spatial detection method, the animal entering, approaching, or present within the designated area, and wherein the spatial detection method excludes the use of Passive Infrared (PIR) motion detectors but may include a sensor monitoring a 3-dimensional space, a camera, a mmWave sensor, etc.

Clause 36: A system for selectively controlling an animal deterrent device, comprising: one or more sensors and one or more processors coupled to a memory storing instructions that, when executed, cause the system to: (i) receive sensor data indicative of motion within a designated area; (ii) classify a detected subject as a human or an animal using a classification algorithm; and (iii) in response to classifying the detected subject as an animal, command a deterrent mechanism to emit a deterring stimulus, and in response to classifying the detected subject as a human, disarm or modify operation of the deterrent mechanism.

Clause 37. The system of clause 36, wherein the classification algorithm comprises at least one of a machine learning model, a neural network, a rule based logic system, or a statistical classifier, and is configured to fuse data from plural sensors.

Clause 38. The system of clause 36 or 37, wherein the one or more sensors comprise at least one of: a mmWave sensor, a time of flight sensor, an ultrasonic sensor, a camera, or a LiDAR sensor.

Clause 39. The system of clause 36, 37, or 38, wherein the instructions further cause the system to determine at least one of: a quantity of animals, a concurrent presence of a human and one or more animals, or a type or category of animal, and to tailor the deterring stimulus based thereon.

Clause 40. A non-transitory computer readable medium storing instructions that, when executed by one or more processors of an animal deterrent device, cause the device to perform operations comprising: receiving distance measurements indicative of activity within a designated area; detecting an animal based on the distance measurements; generating an audio deterrent profile; and driving an acoustic emitter with the audio deterrent profile, while selectively disarming or modifying emission responsive to detection or classification of a human.

Clause 41. The computer readable medium of clause 40, wherein generating the audio deterrent profile comprises producing at least one of: white noise, a frequency sweep, amplitude modulated noise, randomized or pseudo random noise, ultrasonic sound, or a sequence of pre-recorded audio bursts.

Clause 42. The computer readable medium of clause 40 or 41, wherein the operations further comprise uploading or selecting user provided audio files via Bluetooth and/or Wi Fi and reproducing the audio files as the audio deterrent profile.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An animal deterrent device comprising:
a housing;
a controller within the housing;
an animal presence detector configured to be operable for detecting an animal entering, approaching, or being present within a designated area; and
a deterrent mechanism configured to be operable for emitting a deterring stimulus in response to the animal presence detector detecting an animal entering, approaching, or being present within the designated area.

2. The animal deterrent device of claim 1, wherein:
the animal presence detector is configured to be operable for automatically detecting presence of an animal within the designated area; and
the deterrent mechanism comprises a deterring stimulus emitter configured to be operable for automatically emitting a deterring stimulus in response to the animal presence detector detecting the presence of the animal within the designated area.

3. The animal deterrent device of claim 2, wherein the deterring stimulus emitter comprises one or more sound emitters, and wherein:
the one or more sound emitters are configured to emit at least one of: white noise, modulated noise, frequency-swept noise, ultrasonic sound, pre-recorded audio, user-recorded audio, randomized or pseudo-random noise patterns, amplitude-modulated noise, or combinations thereof; and/or
the one or more sound emitters are configured to generate dynamic or temporally varying audio profiles and/or reproduce audio files uploaded to the animal deterrent device via a wired or wireless communication interface(s).

4. The animal deterrent device of claim 1, wherein the animal presence detector includes a distance sensor configured to be operable for providing measurements of distance to a subject to the controller for detection of physical anomalies in the designated area and activation of the deterrent mechanism for emitting the deterring stimulus in response to detection of physical anomalies in the designated area.

5. The animal deterrent device of claim 1, wherein the animal presence detector includes a distance sensor configured such that the distance sensor's field of view and/or angular direction is adjustable.

6. The animal deterrent device of claim 5, wherein the animal deterrent device includes a laser that is rigidly constrained to the distance sensor's adjustability and that can be enabled and/or disabled to aid in alignment of tripwire-like functionality of the distance sensor.

7. The animal deterrent device of claim 1, wherein the animal deterrent device includes a human presence sensor usable for disarming the animal deterrent device when a human is detected in the human presence sensor's range.

8. The animal deterrent device of claim 7, wherein:
the animal deterrent device is configured to be automatically disarmed when a human is detected in the human presence sensor's range; and/or
the human presence sensor is configured to use mmWave radar, camera identification, and/or a Light Detection and Ranging (LiDAR) for detecting a human's presence in the human presence sensor's range.

9. The animal deterrent device of claim 1, wherein the animal deterrent device is connectable with a smart-device via Bluetooth or Wi-Fi to enable a user to configure the animal deterrent device's settings using the smart-device.

10. The animal deterrent device of claim 1, wherein the housing is modular such that a decorative cover may be installed for aesthetics and/or such that various mounts and/or stands can be fitted to the housing.

11. The animal deterrent device of claim 1, wherein the controller is programmable via an on-board interface and/or via a smartphone app through Bluetooth and/or Wi-Fi connectivity.

12. The animal deterrent device of claim 1, wherein:
the animal presence detector includes a distance sensor configured to measure distance to a subject for detection of an animal; and
the distance sensor comprises a Light Detection and Ranging (LiDAR) sensor, a Time of Flight (ToF) sensor, and/or an ultrasonic sensor.

13. The animal deterrent device of claim 1, wherein the deterrent mechanism comprise a sound emitter.

14. The animal deterrent device of claim 13, wherein the sound emitter comprises an ultrasonic sound emitter including an ultrasonic transducer operable with frequencies above 20 kilohertz and/or a speaker operable with frequencies of 20 hertz (Hz) to 20 kilohertz (kHz).

15. The animal deterrent device of claim 1, wherein the deterrent device further includes at least one of, any combination of two of, or all of:
(A) an alignment mechanism;
(B) a human presence sensor; and
(C) a battery pack or no battery pack.

16. The animal deterrent device of claim 15, wherein the animal deterrent device comprises the alignment mechanism that includes a mechanically-adjustable sensor mount that includes a rigidly-fixed laser diode for visual alignment and a rigidly fixed animal presence sensor.

17. The animal deterrent device of claim 15, wherein the animal deterrent device comprises the human presence sensor that is configured to be usable for differentiating between at least one animal and at least one human for auto-disarming or auto-modification of operation of the animal deterrent device.

18. The animal deterrent device of claim 17, wherein the human presence sensor comprises a 24 GHz mmWave presence sensor, a 60 GHz mmWave presence sensor, a camera, and/or a Light Detection and Ranging (LiDAR) sensor.

19. The animal deterrent device of claim 15, wherein the animal deterrent device comprises the human presence sensor, and wherein the human presence sensor and/or the animal presence detector is configured to be usable for differentiating between at least one animal and at least one human for auto-disarming or modification of operation of the animal deterrent device.

20. The animal deterrent device of claim 1, wherein:
the animal deterrent device comprises a rechargeable lithium-ion battery pack that is removable or nonremovable from the housing; and/or
the animal deterrent device is configured to be electrically powered via AA batteries, AAA batteries, 9 volt battery, or other battery(ies); and/or
the animal deterrent device is configured to be electrically powered by plugging an electrical power cord of the animal deterrent device into an outlet.

21. The animal deterrent device of claim 1, wherein the animal deterrent device is configured to detect the presence of at least one human through implementation of a classification algorithm using data from one or more sensors, including one or more of a camera, a Light Detection and Ranging (LiDAR) sensor, a millimeter-wave (mmWave) sensor, a time-of-flight sensor, an ultrasonic sensor, the animal presence detector, and/or a combination thereof.

22. The animal deterrent device of claim 21, wherein responsive to the detection of the presence of at least one human, the animal deterrent device is operable for auto-disarming or auto-modifying operation of the animal deterrent device.

23. The animal deterrent device of claim 1, wherein the animal deterrent device is configured to differentiate between at least one animal and at least one human using a classification algorithm using data from one or more sensors, including one or more of a camera, a Light Detection and Ranging (LiDAR) sensor, a millimeter-wave (mmWave) sensor, a time-of-flight sensor, an ultrasonic sensor, the animal presence detector, and/or a combination thereof.

24. The animal deterrent device of claim 23, wherein responsive to the differentiation of at least one animal and at least one human, the animal deterrent device is operable for auto-disarming or auto-modifying operation of the animal deterrent device.

25. The animal deterrent device of claim 23, wherein:
the classification algorithm is executed by the local controller and/or a remote cloud-based computing service; and/or
the classification algorithm includes a machine-learning model, neural network, rule-based logic system, statistical classifier, or other computational method trained or configured to distinguish humans from animals based on sensor-derived data.

26. The animal deterrent device of claim 23, wherein the animal deterrent device is configured to use sensor-fusion techniques to combine data from multiple sensors to improve classification accuracy.

27. The animal deterrent device of claim 23, wherein the animal deterrent device is configured to use the classification algorithm to determine at least one of, two of, or all of:
a quantity of detected animals;
whether a human is present concurrently with one or more animals; and
a type or category of the detected animal(s).

28. The animal deterrent device of claim 1, wherein the animal presence detector includes a mmWave sensor.

29. The animal deterrent device of claim 1, wherein the animal presence detector is configured to use a spatial detection method for detecting an animal entering, approaching, or being present within a designated area.

30. The animal deterrent device of claim 1, wherein the animal presence detector is configured to use a spatial detection method for detecting an animal entering, approaching, or being present within a designated area, and wherein the spatial detection method excludes using Passive Infrared (PIR) motion detectors but may include using one or more of sensor monitoring of a 3-dimensional space, a camera, and a mmWave sensor.
